(19) United States
(12) Patent Application Publication
(10) Pub. No.: US 2009/0294408 A1
(43) Pub. Date: Dec. 3, 2009

(54) AIR-COOLED COPPER SHOES FOR ELECTROSLAG WELDING APPLICATIONS

(76) Inventor: WILLIAM L. BONG, Walnut Creek, CA (US)

Correspondence Address: LAW OFFICES OF CHARLES L. THOEMING;BIELEN, LAMPE & THOEMING, P.A., TWO CORPORATE CENTRE 1390 WILLOW PASS ROAD, SUITE 1020, CONCORD, CA, 94520, US

(21) Appl. No.: 12/475,110

(22) Filed: May 29, 2009

Related U.S. Application Data
(60) Provisional application No. 61/058,464, filed on Jun. 3, 2008.

(51) Int. Cl. B23K 25/00

(52) U.S. Cl. 219/73.1

(57) ABSTRACT

Opposing, paired and positionally adjustable air cooled welding shoes, run-off tabs, and sumps affixed at the junction of workpieces to be welded with an Electroslag welding system. The air-cooled shoes are capable of being controlled between 800 to 1000 degrees Fahrenheit, resulting in faster welds, smaller heat affected zone in the workpieces welded, and far less base metal dilution. These significant results provide a smaller weld grain structure and much stronger bond in the weld fusion zone.

### CROSS-REFERENCES TO RELATED APPLICATIONS

This United States non-provisional patent application is based upon and claims the filing date of U.S. provisional patent application Ser. No. 61/058,464 filed Jun. 3, 2008.

### STATEMENT REGARDING FEDERALLY SPONSORED RESEARCH OR DEVELOPMENT

None.

### REFERENCE TO A MICRO-FICHE APPENDIX

None.

### TECHNICAL FIELD

This invention relates to welding. More particularly, the invention is related to air-cooled copper shoes for use in welding, particularly for Electroslag welding applications.

### BACKGROUND OF THE INVENTION

Water-cooled copper welding shoes presently used for Electroslag welding applications keep the molten weld metal and flux bath contained in the weld cavity. Water circulates through the copper shoes at a flow rate of approximately 2 gallons per minute. This flow rate is sufficient to keep the copper shoes from melting from excessive heat. In consumable-guide Electroslag welding, the shoes do not move. For longer joints the shoes are repositioned in a leapfrog manner, as welding continues upward. In non consumable guide Electroslag welding the shoes move vertically upward with the vertical rate of rise (VRR) of the molten weld puddle.

Arcmatic™ VertaSlag™ Butt-Weld Water-Cooled Shoes are either cast or machined into the desired shape from pure Oxygen Free, High Conductivity pure Copper (OFHC-101)#101 copper. When cast into shape, the sand mold must provide an interior passage for water flow. A recess (⅛ inch deep by 1 inch wide) is designed into the face of each shoe to shape the weld reinforcement.

Chamfered edges are provided where the copper makes contact with the base material. These chamfered edges help the molten weld metal to wet against the parent material, to provide a smooth transition between the weld metal and the parent material. On conventional water-cooled copper shoes, each shoe has an NPT threaded hole on the input and output for connecting water circulation hose couplings. Internal threaded couplings are attached to the threaded holes and silver-soldered into position to prevent water leaks.

Two relief grooves are cast into the back face of each water-cooled shoe. These relief grooves are to capture a steel, or stainless steel channel that can be attacked to the back of the shoe to reduce wear caused by wedges forced against the back of the shoe. The VertaSlag™ Butt-Weld Shoe is provided in two different sizes: 3 inches wide and 4 inches wide (both available in a variety of lengths.

The Arcmatic™ water-cooled Butt-Weld Shoes are used in pairs on either side of the welding joint. When placed against the parent material, cooling water should always enter the copper shoe from the bottom and exit from the top. Water flowing from the bottom of the copper shoe to the top of the copper shoe reduces the possibility of “vapor-lock” which could stop the flow of cooling water through the shoe.

The water cooled copper shoes excessively cool the base materials on either side of the welding joint, and in turn over-cools the weld puddle. This over-chilling makes it difficult to melt the edges of the base or parent material of the workpieces adjacent to the water-cooled shoes without increasing the voltage levels delivered to the welding torch.

It is, therefore, an object of the air cooled copper shoes to provide a lower welding torch voltage and still attain excellent welting on the edges of the parent material in the weld cavity.

It is a further object of the air cooled copper shoes to operate at a controlled welding shoe temperature range between of between 800 degrees Fahrenheit to 1000 degrees Fahrenheit during the Electroslag welding operation.

It is yet another objective of the air cooled copper shoes to substantially increase the weld travel speed while substantially decreasing the required voltage for the Electroslag welding process.

Other features, advantages, and objects of the present invention will become apparent with reference to the following description and accompanying drawings.

These together with other objects of the invention, along with the various features of novelty that characterize the invention, are described with particularity in the claims attached to and forming a part of this disclosure. For a better understanding of the invention, its operating advantages and the specific objects attained by its uses, reference should be made to the attached drawings and descriptive materials in which there are illustrated preferred embodiments of the invention.

### DISCLOSURE OF INVENTION

To date, the welding industry has always used water-cooled copper shoes to make Electroslag welds. The reason for this is that the molten Electroslag flux puddle is at temperatures of approximately 3500 degrees Fahrenheit during the welding operation. The molten steel being welded melts at a temperature of approximately 2300-to-2500 degrees Fahrenheit. Copper melts at approximately 1900 degrees Fahrenheit. If some form of cooling is not applied to the copper, the temperature of the molten flux and molten steel will melt the copper.

Water-cooled Electroslag shoes do an excellent job in keeping the copper from melting. In addition to keeping the copper from melting, some welding engineers think it is necessary to use the water-cooled copper shoes for also keep the parent material from overheating. To accomplish this they want the water-cooled copper shoes to be a minimum of four inches wide for narrow-gap Electroslag welding. The popular theory is that this water-cooled copper shoe width will keep the heat affected zone (“HAZ”) much smaller, allowing better physical characteristics for a better quality weld. The new addition of narrow-gap Electroslag welding (“ESW-NG”) to the American Welding Standards (“AWS”) D1.5 Bridge code requires that the water temperature to-and-from the water-cooled copper shoes be controlled within a very narrow temperature range. To attain this standard requires a very large flow of cold water to maintain the temperature within the narrow limits of the AWS D1.5 code for ESW-NG welding. The problem with this excessive cooling of the base material on either side of the Electroslag weld joint also over chills the temperature of the weld puddle. This over chilling of the weld puddle makes it very difficult to melt the edges of the parent material nearest to the water-cooled shoes. To have the temperature of the parent material high enough to melt the corners of the weld cavity requires excessively high voltage levels. For instance, a typical welding procedure for heavy plate may require 1000-Amps at 38-Volts. Therefore, the total wattage into the weld can be expressed by the product of Amperage times the quotient of Voltage divided by the travel speed. If the weld is traveling at 2 inches/minute, the heat input equation would be expressed as ((1000-Amps×(38-Volts/2 inches/minute))=32-KiloWatts), resulting in the calculated input wattage into the weld.

The new Arcmatic™ “Air-Cooled VertaSlag™ Butt Welding Shoe™”, using air to cool the shoe (instead of water), allows the copper shoe to heat up to a temperature range of between 800 degrees Fahrenheit to 1000 degrees Fahrenheit. This is possible because the shoe, fittings and plugs are all fusion welded with electron beam fusion welds. If silver solder was used, the solder would melt at a temperature of 1200 degrees Fahrenheit; the fusion weld can heat up to the melting point of copper (approximately 1900 degrees Fahrenheit). If the copper shoes are at a temperature range of between 800 degrees Fahrenheit to 1000 degrees Fahrenheit during the Electroslag welding operation, the voltage can be substantially lowered and still attain excellent wetting on the edges of the parent material in the weld cavity. This allows the previously mentioned weld to be made at 1000-Amps and 28-Volts (instead of 38-Volts). Another factor that affects the total heat input into the weld is that the high temperature of the air-cooled copper shoe, allows the weld travel speed to be substantially increased. If the travel speed is doubled (say to 4 in/min VRR), the total wattage into the weld would then equal 7 kilowatts (1000×28/4=7-KW) instead of the 32 kilowatts required when welding with water-cooled copper shoes—only 22% of the heat input required by water-cooled shoes.

This massive heat reduction will result in the ability of welding faster, with a smaller HAZ and far less base metal dilution. The base metal dilution of the 38-Volt weld will require approximately 50% of the base material, while the 28-Volt weld will require approximately 10-to-20% base metal dilutions. Lower heat input, faster travel speeds, and lower base metal dilution will result in a smaller grain structure in the weld is and a much stronger bond in the fusion zone of the weld.

The air cooled copper shoes make contact with the stiffener and column flange on either side of the weld cavity. They contain the molten puddle and control the wetting action of the weld puddle against the parent material. The shoes are machined to provide perfect fit for shaping the weld, and preventing weld leaks.

Additional air cooled copper shoes are needed in the welding operations where a single stiffener plate extends through a slot cut in the web of the column. A single operation welds the portions of the stiffener above web and below the web. The two copper shoes, as described above, support the weld above the web. The portion of the weld that is below the web must have two additional water-cooled copper shoes. The underside copper shoes are identical to the topside shoes, but the clamping mechanism is different. These shoes are placed into position by a quick clamping mechanism, and held in place by a single threaded screw. The clamping action applies a bias on each shoe with screw pressure, resulting in quick and accurate placement of the shoes. It takes approximately 15 seconds per shoe to place the two bottom copper shoes into position.

Other features, advantages, and objects of the present invention will become apparent with reference to the following description and accompanying drawings.

These together with other objects of the invention, along with the various features of novelty that characterize the invention, are described with particularity in the claims attached to and forming a part of this disclosure. For a better understanding of the invention, its operating advantages and the specific objects attained by its uses, reference should be made to the attached drawings and descriptive materials in which there are illustrated preferred embodiments of the invention.

### BRIEF DESCRIPTION OF DRAWINGS

These and other features, aspects, and advantages of the present invention will become better understood with regard to the following description, appended claims, and accompanying drawings as further described. Six illustrated drawing figures are attached to this document.

FIG. 1 is a front elevation view of an embodiment of a representative air cooled copper shoe 10 for Electroslag welding applications showing dual flow channels 20 and 30 of equal cross-sectional area drilled in a copper buss bar 12, inlet and outlet air manifolds 40 and 50, and two plugs 60 and 70.

FIG. 2 is a side elevation view of the embodiment of a representative air-cooled copper shoe 10 of FIG. 1.

FIG. 3 is a top view of the embodiment of a representative air-cooled copper shoe 10 of FIG. 1.

FIG. 4 is a top view of an embodiment of a representative pair of air cooled copper shoes 10 on either side of an example of an Electroslag weld joint for workpieces 300 and 310 showing the difference in base metal dilution from the heat affected zone 100 for typical water cooled copper shoes and the heat affected zone 90 for the embodiment of a representative pair of air cooled copper shoes 10.

FIG. 5 is a drawing of the ESW-NG Process showing a side view of the parent material workpieces, 300 and 310, the molten flux slag bath 400, and the molten weld metal 410, along with the location of the guide tube 370 and welding wire 372 in relationship to the molten welding puddles, 400 (flux slag bath) and 410 (weld metal).

FIG. 5A is a detail of the guide tube 370, welding wire 372, molten flux slag bath 400, molten weld material 410, and droplet transfer 378 of FIG. 5.

FIG. 6 is schematic of the distributed welding control system 800 for the ESW and ESW-NG welding method and system, including control over the temperature control of the embodiments of air cooled copper shoes, 10 and 200, including the operator's control panel 810 and liquid crystal display (LCD) 820, parallel input and output unit 830, display interface 840, microprocessor control unit 850, operator interface program 852, network interface program 854, system supervisor program 856, and network interface 860.

FIG. 7 is a planar view of the face of the operator control panel 810 of the distributed welding control system 800 of FIG. 6, including the liquid crystal display (“LCD”) 820.

### BEST MODE FOR CARRYING OUT THE INVENTION

One or more specific embodiments of the air-cooled copper shoes for use in welding, particularly for Electroslag welding applications will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developer's specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

My following U.S. Letters Patent are incorporated by reference as if fully set forth herein: U.S. Pat. No. 6,297,472 for Welding System and Method, issued Oct. 2, 2001 (the “'472 Patent”); U.S. Pat. No. 7,038,159 for Electroslag Butt-Welding Expansion Joint Rails, issued May 2, 2006 (the “'159 Patent”); U.S. Pat. No. 7,148,443 for Consumable Guide Tube, issued Dec. 12, 2006 (the “'443 Patent”); and U.S. Pat. No. 7,429,716 for Modular Welding System, issued Sep. 30, 2008 (the “'716 Patent”).

My following pending U.S. non-provisional patent applications are incorporated by reference as if fully set forth herein: U.S. application Ser. No. 11/591,190 for Consumable Guide Tube, filed Oct. 30, 2006 (the “'190 Application”); and U.S. application Ser. No. 12/212,019 for System and Method of Electroslag Welding Spliced Vertical Columns, filed Sep. 17, 2008 (the “'019 Application”).

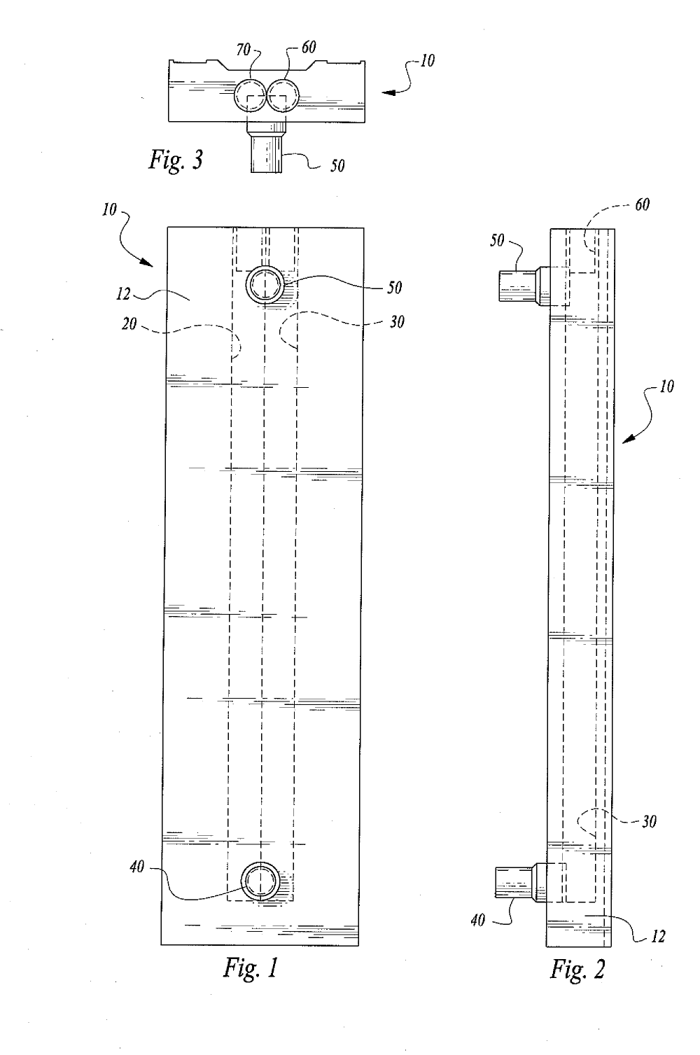

Referring more specifically to the drawings, for illustrative purposes the apparatus for air-cooled copper shoes for application in an Electroslag welding system and method is embodied generally in FIG. 1-7. It will be appreciated that the system may vary as to configuration and as to the details of the parts, and that the method of using the system may vary as to details and to the order of steps, without departing from the basic concepts as disclosed herein. The apparatus for air-cooled copper shoes for application in an Electroslag welding system and method is disclosed generally in terms of welding vertical columns, as this particular type of welding operation is widely used. However, the disclosed apparatus for air-cooled copper shoes may be used in a large variety of Electroslag and or Electrogas welding applications, as will be readily apparent to those skilled in the art.

Referring now to FIGS. 1-7, apparatus for air-cooled copper shoes 10 for application in an Electroslag welding system and method in which at least one workpiece 300 and at least one second workpiece 310 are brought together so that a gap 320 exists between each pair of workpieces. The system 10 comprises at least one stationary welding fixture positioned [not shown] to releasably couple with at least one workpiece. The fixture further comprises at least one pair of opposing welding shoes 10 which are placed on each side of each gap 320 to form at least one welding cavity 340. The air cooled copper shoes 10 of the system make contact with the stiffener and column flange on either side of the welding cavity 340. The air cooled copper welding shoes 10 contain the molten weld material 410 and control the wetting action of the weld material 410 against the parent material of the workpieces, 300 and 310. The air cooled copper shoes are machined to provide perfect fit for shaping the Electroslag weld 420, and preventing weld leaks.

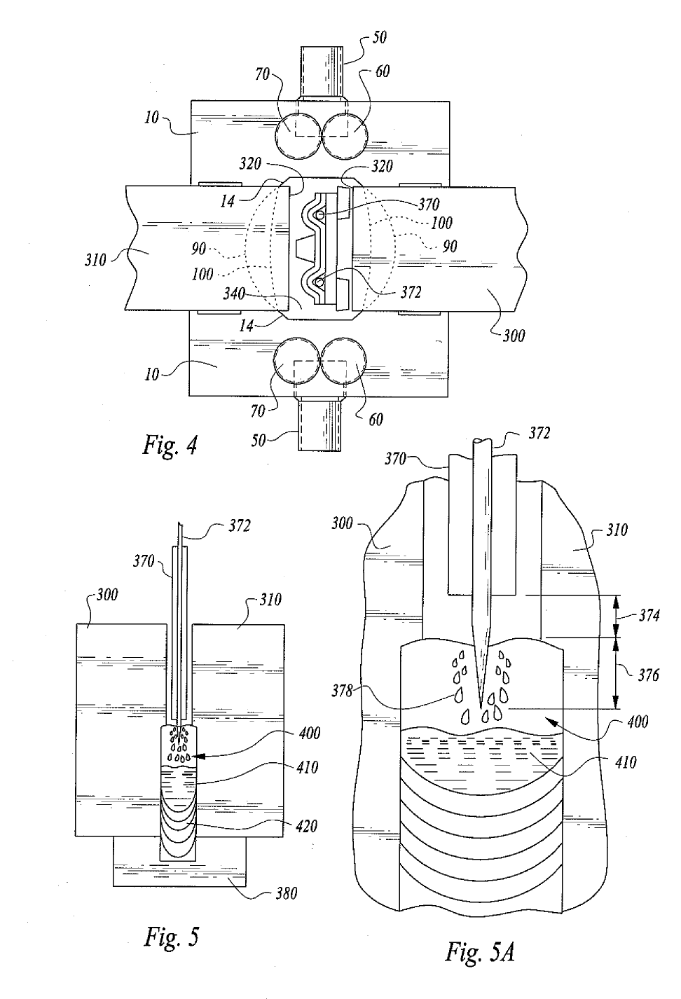

A welding torch [not shown—see, e.g., the '019 Application] is configured to receive at least one consumable guide tube 370 and weld wire 372 which is placed into the welding cavity 340, FIGS. 4, 5, and 5A.

An embodiment of the air cooled welding shoes 10 which further comprise a thermally and electrically insulating coating, at least one sump 380 adjacent to the bottom portion of each welding shoe pair, and at least one run-off tab [not shown—see, e.g., the '019 Application] adjacent to the top portion of each air cooled welding shoe 10 pair. Each pair of welding shoes comprises copper having means for air-cooled temperature control of the shoes.

An embodiment of an Electroslag welding system using the air-cooled welding shoes 10 comprises at least one distributed control system [not shown—see, e.g., the '472 Patent, the '716 Patent, and/or the '019 Application]. Each distributed control system comprises a plurality of controller modules and a common bus connecting each of the plurality of controller modules, wherein each controller module comprises at least one operator control panel module. At least one control system including at least one controller module controls the temperature of the air cooled copper shoes during the Electroslag welding process by regulating the flow of air through the inlet/outlet manifolds, 40 and 50, and circulating through the air flow channels 20 and 30 of the copper buss bar 12 portion of the air cooled copper shoes. The inlet/outlet manifolds, 40 and 50, are adapted to couple to an air circulation system controlled by at least one control system including at least one controller module.

The preferred embodiment of a welding system, in which at least one pair of vertically aligned workpieces, 300 and 310 are brought together so that a gap 320 having a gap center line exists between the workpieces, 300 and 310, comprises: (a) at least one stationary welding fixture [not shown—see, e.g., the '019 Application], each fixture comprising means for releasable coupling [not shown] to at least one workpiece, a pair of opposing air-cooled copper welding shoes 10 placed on each side of the gap 320 to form a welding cavity 340 between the workpieces the shoes, and means for symmetrically positioning the welding shoes 10 adjacent the cavity 340; (b) at least one welding torch [not shown—see, e.g., the '019 Application] configured to receive at least one consumable guide tube 370 which is placed into the welding cavity 40, the welding torch coupled to the welding fixture 12 adjacent to each center line; and (c) apparatus comprising: first and second elongated, parallel rotating shafts [not shown]; first and second linear actuators [not shown—see, e.g., the '472 Patent, the '716 Patent, and/or the '019 Application], the actuators movably mounted on the rotating shafts; means for longitudinally translating the linear actuators along the shafts as the shafts rotate [not shown—see, e.g., the '472 Patent, the '716 Patent, and/or the '019 Application]; means for sensing movement of the linear actuators [not shown—see, e.g., the '472 Patent, the '716 Patent, and/or the '019 Application]; and protective housing means [not shown—see, e.g., the '472 Patent, the '716 Patent, and/or the '019 Application] for enclosing the rotating shafts, the actuators, the longitudinally translating means, and the sensing means, for oscillating each welding torch with the cavity.

An embodiment welding system using air cooled copper shoes 10 includes at least one articulating boom [not shown—see, e.g., the '472 Patent, the '716 Patent, and/or the '019 Application], whereby each welding fixture [not shown—see, e.g., the '472 Patent, the '716 Patent, and/or the '019 Application] is associated with an end of an articulating boom. The welding wire for an embodiment of the system of using the air cooled copper shoes for welding comprises between approximately 0.0001% and approximately 0.05% of boron, and between approximately 0.01% and approximately 0.10% of nickel.

An embodiment of the welding system using air cooled copper shoes further comprises at least one flux dispenser [not shown—see, e.g., the '472 Patent, the '716 Patent, and/or the '019 Application], each flux dispenser comprising: a hopper [not shown—see, e.g., the '472 Patent, the '716 Patent, and/or the '019 Application; a rotating belt positioned below the hopper [not shown—see, e.g., the '472 Patent, the '716 Patent, and/or the '019 Application]; a belt block [not shown—see, e.g., the '472 Patent, the '716 Patent, and/or the '019 Application] having a recessed area housing the rotating belt; and at least one drop tube [not shown—see, e.g., the '472 Patent, the '716 Patent, and/or the '019 Application] associated with a lower portion of the recessed area.

An embodiment of a welding system using the air cooled copper shoes further comprises at least one welding shoe bottom clamping assembly [not shown], each clamping assembly [not shown—see, e.g., the '019 Application] comprising: first and second pairs of air cooled welding shoes 10; means for positionally adjusting the first pair of air cooled welding shoes 10 relative to each other; means for positionally adjusting the second pair of air cooled welding shoes 10 relative to each other; and means for positionally adjusting the first pair of welding shoes relatively to the second pair of welding shoes. The air cooled welding shoes 10 additionally may include a thermally and electrically insulating coating [not shown—see, e.g., the '443 Patent” and/or the '190 Application] on at least one face of each air cooled welding shoe 10.

An embodiment of a representative air cooled copper shoe 10 for Electroslag welding applications provides dual, side-by-side air flow channels 20 and 30 of equal cross-sectional area drilled in a copper buss bar 12, inlet and outlet air manifolds 40 and 50, and two plugs 60 and 70, FIGS. 1-3. The two plugs 60 and 70 are electron beam fusion welded into the top openings to close the top openings drilled into the copper buss bar 12 to form the dual flow channels 20 and 30. Each inlet and outlet air manifold, 40 and 50, respectively communicates with the flow channels 20 and 30. The air cooled copper shoes 10, manifolds, 40 and 50, manifold fittings and plugs, 60 and 70, are all fusion welded with electron beam fusion welds.

An embodiment of a representative pair of air cooled copper shoes 10 on either side of an example of an Electroslag weld joint for workpieces 300 and 310 depicts the difference in base metal dilution from the heat affected zone 100 for typical water cooled copper shoes and the heat affected zone 90 for the embodiment of a representative pair of air-cooled copper shoes 10, FIG. 4.

Chamfered edges 14 are provided where the air cooled copper shoe makes contact with the base or parent material workpieces 300 and 310. These chamfered edges 14 help the molten weld metal 410 to wet against the parent material workpieces 300 and 310, to provide a smooth transition between the weld metal 420 and the parent material workpieces 300 and 310.

Two relief grooves 16 are cast into the back face of each “Air-Cooled VertaSlag™ Butt Welding Shoe™”. These relief grooves 16 are to capture a steel, or stainless steel channel that can be attached to the back of the shoe to reduce wear caused by wedges forced against the back of the shoe. Embodiments of the “Air-Cooled VertaSlag™ Butt Welding Shoe™” are provided in two different width sizes: 3 inches wide and 4 inches wide, and a variety of lengths.

As depicted in FIGS. 5 and 5A, an embodiment of the air cooled welding shoes provides a portion of the weld wire 372 as a submerged wire extension 376 within the molten slag bath 400. Another portion of the weld wire 372 is an un-submerged wire extension 376 above the molten slag bath 400. In this manner, molten flux droplets 378 transfer into the molten weld material 410.

The new Arcmatic™ “Air-Cooled VertaSlag™ Butt Welding Shoe™”, using air to cool the shoe, allows the copper shoe to heat up to a temperature range of between 800 degrees Fahrenheit to 1000 degrees Fahrenheit. This is possible because the shoe, fittings and plugs are all fusion welded with electron beam fusion welds. If silver solder was used, the solder would melt at a temperature of 1200 degrees Fahrenheit; the fusion weld of the system for air cooled copper shoes can heat up to the melting point of copper (approximately 1900 degrees Fahrenheit). If the air cooled copper shoes are maintained at a temperature range of between 800 degrees Fahrenheit to 1000 degrees Fahrenheit during the Electroslag welding operation, the voltage can be substantially lowered and still attain excellent wetting on the edges of the parent material in the weld cavity. This allows the previously mentioned weld to be made at 1000-Amps and 28-Volts (instead of 38-Volts). Another factor that affects the total heat input into the weld is that the high temperature of the air-cooled copper shoe, allows the weld travel speed to be substantially increased. If the welding torch travel speed is doubled (say to 4 in/min VRR), the total wattage into the weld would then equal 7 kilowatts (1000×28/4=7-KW) instead of the 32 kilowatts required when welding with water-cooled copper shoes—only 22% of the heat input required by water-cooled shoes.

This massive heat reduction will result in the ability of welding faster, with a smaller HAZ and far less base metal dilution. For example, the base metal dilution of the 38-V weld will require approximately 50% of the base material, while the 28-V weld will require approximately 10-to-20% base metal dilutions. Lower heat input, faster travel speeds, and lower base metal dilution will result in a smaller grain structure in the weld and a much stronger bond in the fusion zone of the weld.

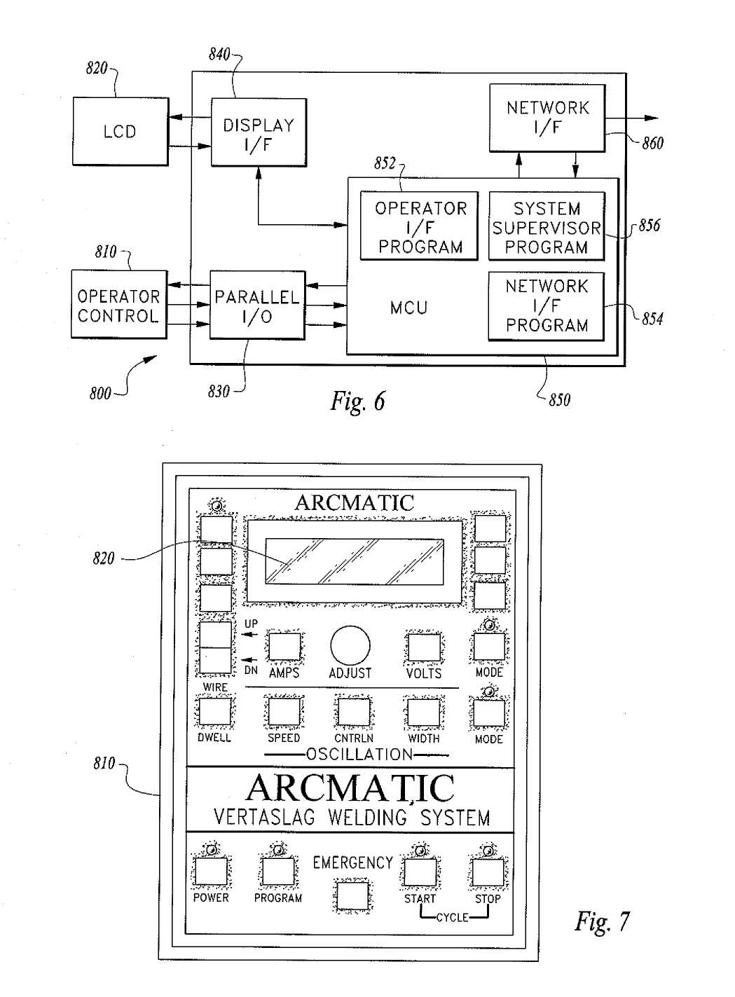

The welding process and the welding procedures for air-cooled copper welding shoes 10 including, but not limited to, the “Air-Cooled VertaSlag Butt Welding Shoe,™” can be pre-programmed into the Arcmatic™ programmable, computer controlled integrated welding system, FIGS. 6-7. The Arcmatic™ distributed welding control system 800 provides fully automatic control over the air-cooled copper welding shoes and related welding process from the operator's control panel 810. The automated control of the air-cooled copper welding shoes components includes a single pendant controller that provides overall system control for a number of discreet motion control networks including microprocessor modular distributed control of each welding torch, each welding torch slide assembly, countercurrent air circulation through the copper shoes, each wire feed conduit, each high current welding cable, welding power supply, and each Electroslag weld within each welding cavity through a system supervisor program 856, network interface program 854, and an operator interface program 852 of a microprocessor control unit 850. Accordingly, the welding operator for any disclosed method and system of welding using air-cooled copper shoes principally needs to be a skilled operator capable of setting up the weld and running the pre-qualified welding programs. The same welding control system and methods used for Arcmatic™ VertaSlag™ welds of the '019 Application and/or the '297 Application, and/or the '472 Patent, the '716 Patent, and/or the '159 Patent, are used to operate and control the method and system of welding including, but not limited to, automating the air-cooled copper shoes “on the job” in the field.

Therefore, the foregoing is considered as illustrative only of the principles of the invention. Additionally, since numerous modifications and changes will readily occur to those skilled in the art, it is not desired to limit the invention to the exact construction and operation shown and described, and further, all suitable modifications and equivalents may be resorted to, falling within the scope of the invention.

I claim:

1. Air cooled welding shoes for Electroslag welding systems, the air cooled shoes comprising, in combination:
a) at least one copper buss bar having a forward face and a backward face;
b) at least one first dual flow air channel within each copper buss bar, each first dual flow air channel having an upper section and a lower section;
c) at least one second dual flow air channel within each copper buss bar, each second dual flow air channel having an upper section and a lower section;
d) at least one air flow manifold communicating with the first and second dual air flow channel lower sections;
e) at least one air flow manifold communicating with the first and second dual air flow channel upper sections;
f) a first copper shoe plug capping each first dual flow air channel upper section;
g) a second copper shoe plug capping each second dual flow air channel upper section;
h) means for controlling the temperature of the air cooled copper shoes.

2. The air cooled copper shoes of claim 1, wherein all channels, manifolds, and plugs are fusion welded with electron beam fusion welds.

3. The air cooled copper shoes of claim 1, wherein the temperature of the air cooled copper shoes is maintained at a temperature range of between 800 degrees Fahrenheit to 1000 degrees Fahrenheit during the Electroslag welding operation.

4. The air cooled copper shoes of claim 1, wherein the shoes further comprise at least one chamfered edge on the forward face of each copper buss bar.

5. The air cooled copper shoes of claim 1, wherein the shoes further comprise at least two relief grooves cast into the backward face of each copper buss bar.

6. The air cooled copper shoes of claim 1, wherein lower and upper air flow manifolds are cast into the backward face of each copper buss bar.

7. The air cooled copper shoes of claim 1, wherein means for controlling the temperature of the air cooled shoes comprises at least one distributed control system having at least one controller module for regulating the countercurrent flow of air through the manifolds and air flow channels of each air cooled shoe.

8. Air cooled welding shoes for Electroslag welding systems, each air cooled shoe comprising, in combination:
a) at least one copper buss bar having a forward face and a backward face, and comprising at least one chamfered edge on the forward face and at least two relief grooves cast into the backward face;
b) at least one electron beam fusion welded, first dual flow air channel within each copper buss bar, each first dual flow air channel having an upper section and a lower section;
c) at least one electron beam fusion welded, second dual flow air channel within each copper buss bar, each second dual flow air channel having an upper section and a lower section;
d) at least one electron beam fusion welded, air flow manifold communicating with the first and second dual air flow channel lower sections through the backward face of each copper buss bar;
e) at least one electron beam fusion welded, air flow manifold communicating with the first and second dual air flow channel upper sections through the backward face of each copper buss bar;
f) an electron beam fusion welded, first copper shoe plug capping each first dual flow air channel upper section;
g) an electron beam fusion welded, second copper shoe plug capping each second dual flow air channel upper section;
h) at least one distributed control system having at least one controller module for regulating the countercurrent flow of air through the manifolds and air flow channels of each air cooled shoe for controlling the temperature of the air cooled copper shoes at a temperature range of between 800 degrees Fahrenheit to 1000 degrees Fahrenheit during the Electroslag welding operation.
